(19) United States
(12) Patent Application Publication
(10) Pub. No.: US 2005/0228691 A1
(43) Pub. Date: Oct. 13, 2005

(54) Automated wellness system managing personalized fitness programs

(76) Inventor: Michael Paparo, Fort Lauderdale, FL (US)

Correspondence Address: AKERMAN SENTERFITT, P.O. BOX 3188, WEST PALM BEACH, FL, 33402-3188, US

(21) Appl. No.: 10/819,744

(22) Filed: Apr. 7, 2004

(51) Int. Cl. G06F 17/60

(52) U.S. Cl. 705/2

(57) ABSTRACT

A method for providing personalized wellness programs can include the step of receiving participant metrics, the metrics including data elements indicative of a plurality of mental and physical attributes relating to wellness of an associated participant. Numerical weights can be assigned to selective ones of these metrics. A wellness program can be algorithmically determined based at least in part upon the assigned weights. The wellness program can include multiple stages. A first one of these stages can be presented to the participant. The participants performance of the first stage of the program can be automatically evaluated using a data-driven approach. The performance evaluation can be based at least in part upon the participant metrics. A second one of the stages can be presented when the evaluated performance indicates a successful completion of the first stage.

### BACKGROUND

1. Field of the Invention

The present invention relates to the field of wellness and fitness and, more particularly, to an automated system for managing personalized fitness programs.

2. Description of the Related Art

Dieting is out of control in the United States. People have been socially conditioned to have a distorted perception of their own body form and to have a distorted view of what being in a physically healthy state should mean. Consider that most fashion models are thinner than 98% of American woman. Contrast this statistic with the fact that Marilyn Monroe, during her years of prominence, fluctuated between a dress size 14 and 18, which would be considered overweight by today's standards. Contemplate that four out of five American women say they are dissatisfied with the way they look. Ponder that on any given day, approximately half the women and one forth of the men in the United States are on a diet. Further, almost half of American children between first and third grades say that they want to be thinner.

Reflect upon a society that spends over forty billion dollars a year on dieting and diet related products. Surveys indicate that more than one out of three “normal dieters” progress to pathological dieting at some point in their lifetime—one fourth of those people will suffer from a partial or full syndrome eating disorder. Surveys also suggest that between five and ten million females and approximately one million men struggle with eating disorders and borderline conditions. Ruminate that the number of people with eating disorders and borderline conditions in the United States (approximately 2 million people at any time) is roughly triple the number of people living with Acquired Immune Deficiency Syndrome (AIDS) (slightly over 650, 000 people). Further, although approximately 2.2 million people live with schizophrenia, eating disorders affect at least three times as many people as schizophrenia does.

The personal consequences to distorted body perceptions can be devastating and the associated mental risks manifold. Feelings of guilt, inadequacy, depression, and low self-esteem are common accompaniments of distorted body perceptions. Worse, a person's personal fixation with perceived physical inadequacies can be reinforced by external forces. That is, people crave social acceptance and America's obsession with thinness can perpetuate unhealthy behavior and nutritional deficiencies.

Conventional diets and dietary programs can be ineffective. The focus of most conventional diets is to change the mass of an individual, from a starting mass to a target mass. Such programs are designed to address the symptom, but not the source of the underlying problems that resulted in an undesired physical state. Regardless of how massive a person is, fatness or thinness is intricately tied to a state of mind. Morphing a body form without altering this state of mind is at best a temporary resolution of a far deeper dilemma. This is why so many dieters oscillate between excessively bulky and excessively waif-like states. The oscillations can cause dieters to degenerate mentally and physically, further perpetuating and ingraining the problems associated with having a perceptually unpleasing body form.

More specifically, a “fat person” has a mind-set that contains thoughts, cravings, attitudes, and habits that drive an individual to be obsessed by food. This mind-set is independent of body mass. No matter what a fat person does, the mind-set will always prevent such a person from having a healthy relationship with their body, thereby often preventing a fat person from living a satisfying and empowering life.

In contrast, a “thin person” is not constantly dominated by thoughts about food and/or their body form. A thin person exhibits sane eating habits. That is, a thin person eats when hungry and stops eating when full. Regardless of their mass, a thin person is not physically, mentally, and socially controlled by food. Rather, a thin person's relationship with food and their body is natural, and is delegated to a peripheral facet of their life. Consequently, a thin person is both mentally and physically healthy.

A need exists for establishing a wellness program that transforms a fat person into a thin person. It should be appreciated that such a program should conjunctively address both physical and mental hurdles that must be overcome before a fat person can be transformed into a thin person. Because each fat person has experienced different re-enforcing events that have resulted in their current state, the program should be tailored for specific individuals. Further, such a program should dynamically adjust itself over time, so that the program adapts itself in accordance with changes in the mental and physical states of the participants.

### SUMMARY OF THE INVENTION

A method, system, and apparatus for establishing personalized wellness programs that transform participants into thin people in accordance with the inventive arrangements disclosed herein. More specifically, the subject matter disclosed herein provides an automated computer system that dynamically devises wellness programs based upon a multitude of metrics. The metrics can include psychological, physiological, program history, and other data points that can be securely and confidentially stored within a data store. A multitude of tools can be provided as part of the wellness program. For example, tools can include educational classrooms, exercise routines, psychological counseling, support groups of similarly situated participants, online experts, and the like. Particular ones of the tools can include tests, the participant needing a predetermined test score before the participant can progress to further stages in the wellness program. That is, a participant may have to pass a test that indicates the achievement of a mental milestone before one or more physical milestones and program specifics established to achieve the physical milestones are revealed to the participant.

In one embodiment, each participant can be matched with a digital wellness coach having a simulated personality selected to match the participant. For example, a selected coach can appear soft spoken, kind, understanding, ruthless, bossy, and the like. Different coaches can also be tailored for the age, gender, intelligence, ethnicity, and/or goals of the participant. When a participant has trouble overcoming a milestone, a different digital coach can temporarily be assigned until the problematic milestone is overcome. Each digital coach can emphasize different program aspects and can determine appropriate program milestones and/or offer different suggestions. Such coach-based program tailoring can be achieved by assigning a series of weighted factors to each coach, where the coaches' factors can be combined with weights generated from participant metrics to ultimately compute a suitable wellness program tailored for the needs of the participant.

One aspect of the present invention can include a method for providing personalized wellness programs. The method can include the step of receiving participant metrics, the metrics including data elements indicative of a plurality of mental and physical attributes relating to wellness of an associated participant. Numerical weights can be assigned to selective ones of these metrics. A wellness program can be algorithmically determined based at least in part upon the assigned weights. The wellness program can include multiple stages. A first one of these stages can be presented to the participant. The participants performance of the first stage of the program can be automatically evaluated using a data-driven approach. The performance evaluation can be based at least in part upon the participant metrics. A second one of the stages can be presented when the evaluated performance indicates a successful completion of the first stage.

It should be notated that the invention can be implemented as a program for controlling a computer to implement the functions described herein, or a program for enabling a computer to perform the process corresponding to the steps disclosed herein. This program may be provided by storing the program in a magnetic disk, an optical disk, a semiconductor memory, any other recording medium, or distributed via a network.

Another aspect of the present invention can include a system for establishing personalized wellness programs including a participant data engine, a program engine, a coach engine, and/or wellness tools. The participant data engine can security store participant metrics. The program engine can establish and maintain personalized wellness programs for program participants. Each wellness program can be customized for a participant based upon the participant metrics. The wellness programs can include a multitude of progressive stages, where at least a portion of these stages require a mental milestone to be achieved before successful stage completion and at least a portion of the stages requiring a physiological milestone to be achieved before successful stage completion. The coach engine can include a multitude of digital coaches, each coach having an associated appearance, simulated personality, and coaching style. Each coach can interactive guide a participant through the wellness program designed for the participant. The wellness tools can include, but are not limited to, a college tool, a nutritional laboratory tool, a gym tool, and/or a library tool.

### BRIEF DESCRIPTION OF THE DRAWINGS

There are shown in the drawings, embodiments that are presently preferred, it being understood, however, that the invention is not limited to the precise arrangements and instrumentalities shown.

FIG. 1 is a schematic diagram illustrating an automated wellness system in accordance with the inventive arrangements disclosed herein.

FIG. 2 is a graphical user interface for one embodiment of an interactive wellness application in accordance with the inventive arrangements disclosed herein.

FIG. 3 is a schematic diagram illustrating one embodiment of a system in which the wellness program computing components can operate in accordance with the inventive arrangements disclosed herein.

FIG. 4 is a flow chart illustrating a method for establishing an automated wellness program in accordance with the inventive arrangements disclosed herein.

### DETAILED DESCRIPTION OF THE INVENTION

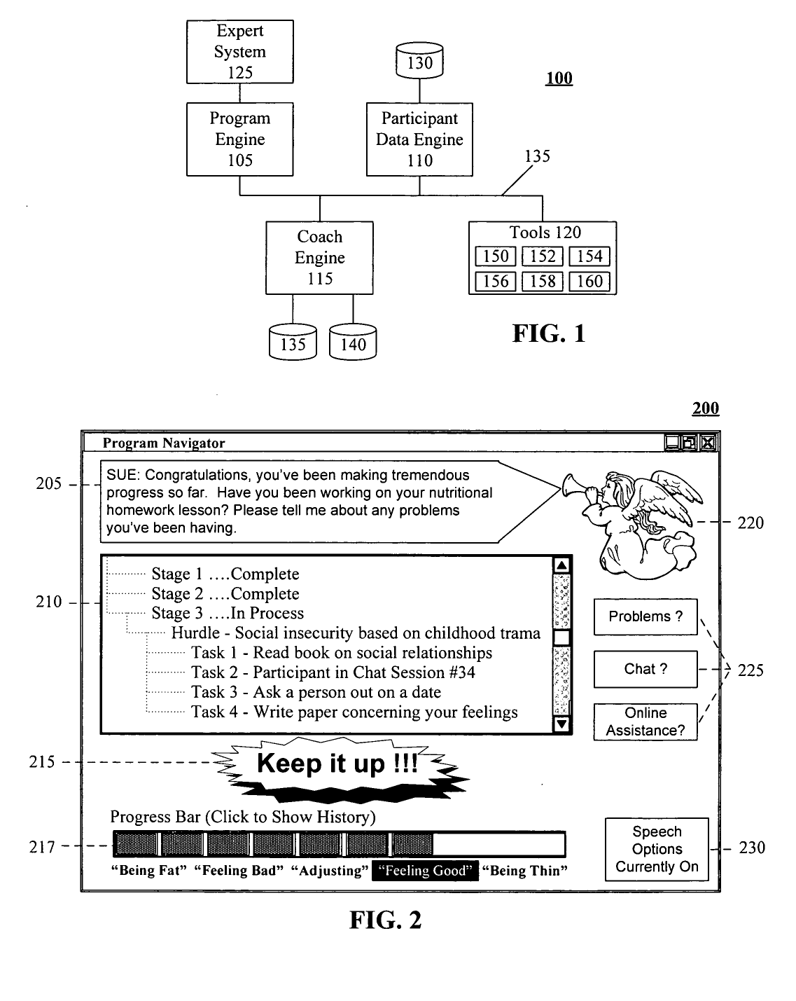

FIG. 1 is a schematic diagram illustrating an automated wellness system 100 in accordance with the inventive arrangements disclosed herein. The system 100 can include a participant data engine 110, a program engine 105, a coach engine 105, and tools 120 communicatively linked via bus 135. The bus 135 can include any communication pathway, such as a circuitry link, a wireless connection, and/or a network connection.

The participant data engine 110 can store metrics for each participant. The participant data engine 110 can also utilize one or more data repositories 130, which can be distributed across a network space. In one embodiment, the participant data engine 110 can securely encrypt participant metrics so that only the appropriate participant and the automated system are privy the metric data. In some instances where metric data is conveyed outside the system 100 or monitored by system administrators, the identity associated with metric values can be redacted or obscured by the participant data engine 110 to ensure information confidentially.

The program engine 105 can compute participant-specific wellness programs in a data-driven fashion using information provided by the participant data engine 110. Each participant unique wellness program can include a multitude of different stages, particular ones of which execute in parallel and particular ones of which execute in series with other stages. Different ones of these stages can be presented to a participant as the participant progresses in the program.

For example, stage one of an illustrative wellness program can focus on a mental hurdle that has habitually resulted in participant weight gain. Stage two of the same program can include a rudimentary fitness program designed to slowly enable the participant to walk for one mile a day. Stage three of the program can initialize a dietary and nutrition segment of the program. The program engine 105 can determine, based upon participant metrics, that stage one and stage two can be performed simultaneously. Stage three of the program, however, may not be initiated before both stage one and stage two have been successfully performed.

Accordingly, programs can be tailored so that dietary requirements are not imposed upon a participant before the participant have overcome a few of the critical hurdles that represent the underlying source of difficulties resulting in an undesirable body form. That is, participants are not expected to overcome all their problems at once. Instead, problems and hurdles can be overcome incrementally, thereby preventing a participant from being overwhelmed and ultimately fail, as is common with conventional, non-personalized dietary plans.

In one embodiment, the program engine 105 can contain of a multitude of tables with values. These values can collectively represent ranges of physical, nutritional, fitness, interpersonal, and mental conditions that a participant may have. Participant metrics from the participant data engine 110 can determine what ranges a selected participant falls within. The conditions for the participant can then be ordered in an order of severity or other such ordering appropriate for the program. Early stages of the personalized wellness program can focus upon the detected conditions that are to be overcome. As conditions are overcome, the participant metrics can be updated and the program engine 105 can recalculate new conditions applicable to the program participant.

In a particular embodiment, the program engine 105 can utilize an expert system 125 to device personalized wellness programs. The expert system 125 can determine stages for a participant based upon probabilities that each stage would result in a desired state. These probabilities can be heuristically determined using a trained neural network. Of course, the expert system 125 is not limited to this approach, and any programmatic technique can be utilized. For example, a fuzzy logic engine can be utilized to determine present participant shortcomings and to suggest possible stages for the participant.

The coach engine 115 can manage the implementation and control of the various digital coaches utilized throughout the program. A digital coach being a personality designed to constantly engage participants. Data store 135 can contain presentation elements for digital coaches. Presentation elements can include such elements as animation, visual presentation, grammar and idiom, prosodic characteristics of synthetically generated speech, and the like. Data store 140 can include content and behavioral coach characteristics. That is, each digital coach can exhibit a unique coach-specific approach and/or coach-specific preferences in the same manner that each personal trainer, friend, or physiologist can convey different solutions to a person when presented with a problem. The behavioral characteristic of the selected digital coach can alter the specifics generated for a participant by the program engine 105.

The tools 120 can include a multitude of different resources, automated and real, that can assist a participant within the wellness program. The tools 120 can include, but are not limited to, a program navigator 150, a homeroom 152, a college 154, a nutrition lab 156, a gym 158, and/or a library 160.

The program navigator 150 can provide a wellness program progression for a participant. That is, the program navigator 150 can present past program challenges that have been overcome, current challenges to be overcome, and provide guided requirements and/or milestones as well as test to assure these milestones have been met.

The homeroom 152 can be a virtual classroom where wellness participants can turn in assignments, receive guidance through a homeroom digital coach, and interact with other program participants assigned to the same homeroom 152. In one embodiment, attendance at the homeroom 152 can be mandatory. Participants that fail to attend the homeroom 152 at the designated times, fail to listen to the homeroom digital coach, and/or are truant in their homework assignments can be accessed penalties, can be suspended from the wellness program and/or can be expelled. Accordingly, the homeroom 152 can emphasize the seriously of active participation within the wellness program in the same manner that classrooms and teachers ensure students provide an honest effort in scholastic endeavors.

The college 154 is a virtual environment designed to teach participants key concepts towards achieving self-actualization. Lessons in the classroom can emphasize the concepts of commitment, intention, fortitude, goals, successes, failures, social dynamics, and the like. Each of the lessons can be followed by a test, where a minimum score is required for progression. Continuous failure in the tests can result in penalties, participant suspension, and/or expulsion from the program.

The nutrition lab 156 can be virtual environment representing a food lab. Visually, the nutrition lab 156 can include graphical decorations showing the food pyramid, food groups, caloric tables for various foods, and the like. The nutrition lab 156 can be used to teach participants about the science of foods, eating habits, nutritional affects on the body, diseases associated with poor nutrition, and the like. Like the college 154, various tests can be administered after lessons have been provided. A minimum test score can be required for progression within the program.

The gym 158 can structure a personal exercise/workout program for participants. Particular ones of these workouts, such as walking and/or jogging, can be performed by the participants alone. Other exercises can require a membership with a physical gym or fitness club. The gym and/or fitness club can be electronically provided with participant exercise details. That is, details for the participant can be constructed by the gym 158 and transferred to the physical gym of which the participant is a member. Thereafter, personal trainers can be assigned to assure that participants are properly following the assigned routines.

In one embodiment, different physiological monitors can also be used to monitor a participant's performance in the gym 158. For example, heart monitors attached to an exercise bike can be communicatively linked to system 100 to assure gym 158 assignments are carried out. These physiological monitors can be communicatively linked to the gym 158 via a communication link, such as an Internet connection.

The library 160 can contain inspirational writings, stories, poetry, and literature that are available to the participant upon request. Books available via the library 160 can be integral to homework assignments and tests assigned throughout the program. In addition to being used for assignments, participants can be encouraged to periodically browse the library to develop a healthier attitude towards themselves, fitness, and others that will aid them throughout the program. Library 160 books can be physical books transported to the participant upon request, electronic books made accessible to the participants, and/or suggested books that participants can purchase or acquire locally though bookstores and libraries.

It should be noted that the system 100 can execute within a suitable operating system and one or more applications can be implemented for controlling the various functions of the system 100. For example, the program engine 105 can execute within a server communicatively linked to a client via a browser. In another example, the program engine 105 can be a stand-alone application that synchronizes data with a remotely accessible data store.

Additionally, any operating system, which can support the execution of one or more applications intended to run on that platform and which support operation of the various functions and features disclosed herein, can be used in system 100. For example, as the tools 120 can include one or more remote services, a portion of which have been implemented within a LINUX server, while other tools can be implemented within one or more UNIX servers and/or within a WINDOWS based platform.

The system 100 can also include one or more interface ports (not shown) used to physically connect devices and/or peripherals to the system 100. For example, an interface port can be a standard wall jack to initiate telephone calls over the Public Switched Telephone Network (PSTN). An interface port can also include a universal serial bus (USB) port, a firewire (IEEE 1394) port, a parallel port, a COM port like an RS-232 port, an ethernet port, an audio port, or the like.

Each of the various components of the system 100 disclosed herein can be communicatively linked with one another using appropriate circuitry, whether through one or more memories one or more additional interface processors or logic controllers, and/or the communications bus 135. For example, while each of the elements described herein is depicted as being linked to the communications bus 135, it should be appreciated that each element can be configured to communicate with a processor through a suitable interface, such as a digital input and/or output or through an intermediate interface processor, for example using an interrupt request of the processor.

Additionally, one skilled in the art will recognize that the various components disclosed herein can be embodied in various other forms and that the configuration disclosed and described with reference to FIG. 1 is provided for purposes of illustration only. For example, the various components can be implemented as one or more discrete components, as one or more processors, logic controllers, and/or DSP's, or any combination thereof.

FIG. 2 is an graphical user interface (GUI) 200 for one embodiment of an interactive wellness application in accordance with the inventive arrangements disclosed herein. The GUI 200 illustrates a program navigator that tracks progress of a participant throughout various stages of a personalized wellness program. The GUI 200 can include a digital coach 220, a coach dialogue 205, a progress tree 210, participant specific encouragements 215, a progress bar 217, interaction buttons 225, GUI options 230, and the like.

The digital coach 220 can be a personal guide and confidant for a participant. Information told to the digital coach 220 can be encrypted and secured, thereby remaining confidential between the participant and the automated system. The digital coach 220 can be represented by a static or an animated image. Further, the digital coach 220 can have a unique grammar and speech tonal characteristics. For instance, each digital coach 220 can be associated with a concatentative text-to-speech voice and a customized speech recognition grammar.

A digital coach 220 can have a simulated personality designed to engage the participant. As such, a participant can select a digital coach 220 from a set of available coaches to match the participant's needs, desires, and/or personality. As a participant interacts with the digital coach 220 the digital coach 220 can be dynamically adjusted using learning algorithms and participant feedback.

Any of a variety of simulated representations can be used for a digital coach 220. For example, a digital coach 220 can be a designated age, can speak a configurable language, can be a set gender, and the like. In one embodiment tailored towards children, fictitious characters, such as cartoons, animals, trucks, and the like can be digital coaches 220. In another embodiment, a digital coach 220 can be a simulation of a particular person, such as an actor, a politician, a historical figure, a relative, and the like. A digital coach 220 can have a gambit of simulated personalities from aggressive to shy, taciturn to expressive, warm to cold, gentle to tough, etc.

The coach dialogue 205 can visually and/or audibly present comments from the digital coach 220 to the participant. The comments can be specifically configured toward the participant, current events, and the personality of the digital coach 220.

The progress tree 210 can visually illustrate the participant's progress within the program. In one embodiment, the progress tree 210 can be constructed of interactively expandable nodes, each node expansion detailing program specifics relating to the participant. The progress tree 210 can present milestones that must be achieved for a given stage, list tasks designed to help the participant overcome hurdles to reaching the milestone, and other stage relevant data.

The encouragements 215 can appear randomly within the GUI 200 to motivate the participate. Encouragements 215 can be customized for the participant to help overcome identified physical and mental hurdles and to provide re-enforcement of desired behavior and/or mental states.

The progress bar 217 can graphically show progress that a participant has made within the program. Unlike traditional wellness programs that focus upon weight, the progress indicated in the progress bar 217 can be weight independent, representing a customized progress score for the participant, thereby permitting a participant to progress without being overly fixated on intermittent weight changes. The progress score can be based upon a multitude of factors, such as eating habits, psychological progress, nutritional knowledge, body fat composition, exercise progress, cholesterol level, and any other participant metric. Different weights can be applied to different factors. Further, different participants can have differentially weighted factors for purposes of computing the progress score.

Clicking on the progress bar 217 can activate a window showing dates and milestones achieved in the program, each having a brief explanation. Presentation of the participant's progress can be used to re-invigorate the participant so that further progress can be made and so that the participant does not become apathetic. Showing progress details can be especially important to encourage participants who are making progress in the program, when such participants have reached a temporary weight plateau. It should be noted that the progress bar 217 can include any graphic element, such as a slide, a pie chart, a goal thermometer, and is not limited to the illustrative visualization presented herein.

The interaction buttons 225 can trigger any of a variety of other views and/or tools to be presented to the participant. The interaction buttons 225 can be linked to elements within the GUI 200 and can have dynamically adjustable behavior dependant upon other selected GUI 200 elements.

For example, if a second task appearing in the progress tree 210 is highlighted, and an interaction button 225 is selected, the button can result in action associated with the second task. More specifically, an online assistance button can be selected while a chat session task is selected. As a result of button selection, online assistance button relating to a chat session can be provided.

The GUI options 230 can permit a participant to customize one or more environmental aspects of the GUI 200. For example, the GUI options 230 can toggle speech generation and automatic speech recognition (ASR) features of the application between enabled and disabled states. In another example, the GUI options 230 can enable/disable automated features associated with the digital coach 220. Moreover, the GUI options 230 can also change the color, text size, font, appearance, and the like of the GUI 200.

It should be appreciated that the various GUIs, including GUI 200, disclosed herein are shown for purposes of illustration only. Accordingly, the present invention is not limited by the particular GUI or data entry mechanisms contained within views of the GUI. Rather, those skilled in the art will recognize that any of a variety of different GUI types and arrangements of data entry, fields, selectors, and controls can be used without departing from the essential spirit of the inventive arrangements disclosed herein.

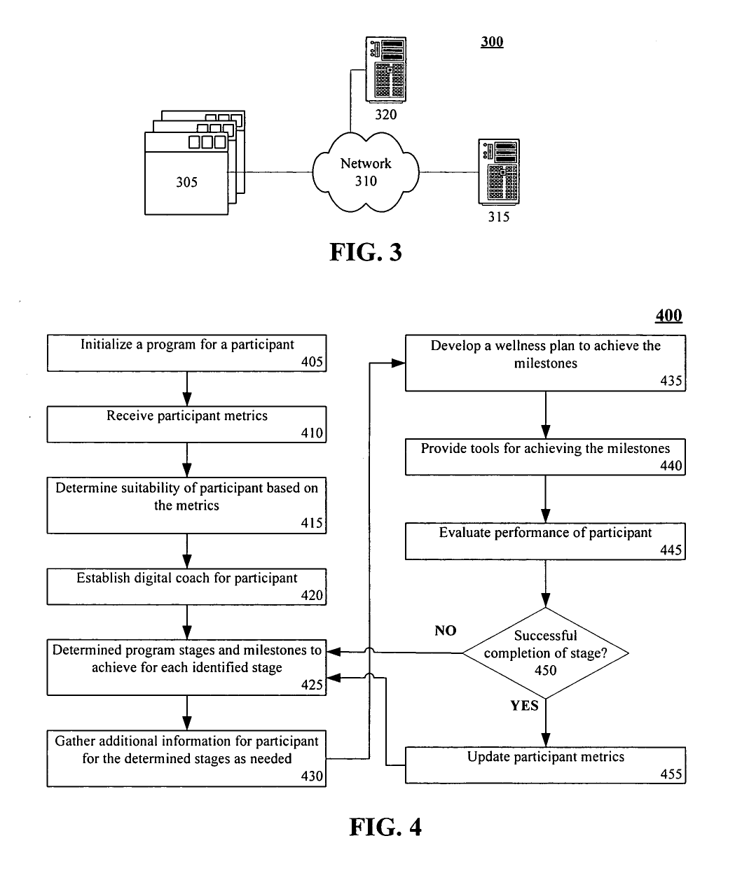

FIG. 3 is a schematic diagram illustrating one embodiment of a system 300 in which the wellness program computing components can operate in accordance with the inventive arrangements disclosed herein. System 300 can include a client application 305, a network 310, a wellness server 315, and a remote server 320. The client application 305 can be hosted upon a stand-alone computing device and/or can be hosted upon a thin client that requires interaction with a remotely located wellness server 315. The client application 305 can be executed upon a variety of computing platforms having varying capabilities.

For example, in one embodiment, the client application 305 can be executed on a personal computer having a GUI. In another embodiment, the client application 305 can be hosted upon a mobile telephone, a personal data assistant (PDA), a computing tablet, or other such mobile computing device. In yet another embodiment, the client application 305 can be executed upon a pervasive wearable computing device. In still another embodiment, the client application 305 can be a voice enabled telephony application that interacts with a participant via telephony customer premise equipment and an audio interface.

The wellness server 315 can include any of a plurality of computing components necessary to automatically establish, manage, and implement the wellness programs as described herein. For example, the wellness server 315 can include the components detailed in system 100. The wellness server 315 can be a centralized server and/or can consist geographically distributed components resulting a dispersed configuration. That is, the wellness server 315 can be implemented within a grid computing environment or other such non-centralized arrangement.

One or more remote servers 320 can provide programmatic functionality for the wellness server 315 and/or the client application 305. For example, the remote server 320 can provide a Web service, such as an ASR service and/or a synthetic speech generation service, utilized by the wellness server 315. In another example, the remote server 320 can provide services directly to the client application 305.

For example, one component of the wellness program established for a participant can include the dietary program having dedicated Web site. The client application 305 can communicatively link the participant to the remote server 320 hosting the Web site via the network 310.

The network 310 can communicatively link the client application 305, the wellness server, and the remote server 320 to one another. The network 310 can include packet based communication connections, such as an intranet or an Internet, as well as circuit based communication connections, such as those available via the Public Switched Telephone Network (PSTN). Additionally, the network 310, can include land based communication links as well as wireless communication links. Wireless communication links can include but is not limited to such communication links as BLUETOOTH, WIFI (referring to one of the 802.11 family of wireless protocols), radio frequency links, satellite links, and the like.

FIG. 4 is a flow chart illustrating a method 400 for establishing an automated wellness program in accordance with the inventive arrangements disclosed herein. The method can be performed in the context of automated computer system that includes a data repository for storing participant metrics. The automated computer system also include a program generation engine that generates personalized wellness programs based upon the individuals metrics.

The method can begin in step 405 where a program for a participant can be initialized. In step 410, an automated system can receive participant metrics. These metrics can include answers to a multitude of personal questions that together can generate a psychological and/or physiological profile of the participant. The participant metrics can, for example, describe information about the participant's life including but not limited to present and past physical data, medical history, personality traits, past and present behaviors and behavioral patterns, successes, failures, habits, relationships, feelings, self-esteem evaluations, dreams, aspirations, goals, ethnicity, and the like. Program specific metrics can also be gathered including interaction preferences, commitment level in regards to the program, desktop and/or interactive device configuration information, and the like.

In step 415, participant suitability for the program can be determined based upon the metrics. In one embodiment, suitability can be determined algorithmically by assigning weighted values to selective ones of the participant metrics. In such an embodiment, the weights can be totaled and compared against a previously established threshold value representing a minimum requirement for program participation. Because not all questions resulting in participant metrics require answers, the threshold value comparison can assure sufficient participant metrics have been provided to generate a viable customized wellness program for the participant.

In another embodiment, program suitability can be determined heuristically. For example, a learning neural network can be fed training data including sample participant metrics as well as data indicating whether the participant associated with a metric set successfully completed the program. Accordingly, the automated system can be a self-learning, dynamically adjusting artificially intelligent computer system that assures a target success rate is achieved over time by establishing a feedback loop so long as a correlation exists between initially provided participant metrics and program success.

In step 420, a digital coach can be established for the participant. In one embodiment, a user can directly select a digital coach. In another embodiment, the automated program generation system can limit a selection of available coaches to ones determined to be suitable for the applicant. The applicant can then select a digital coach from among this limited set of coaches. In still another embodiment, a participant can be automatically provided a digital coach based upon associated metrics and the coach most closely matching the needs of the applicant. In step 425, program stages and milestones to be achieved for an identified stage.

In step 430, additional information can be gathered for the participant as needed. Additional information may be needed before the computer system can determine plan specifics to assist the participant in reaching a specific milestone. In step 435, a detailed wellness plan can be generated to achieve a current milestone, thereby permitting the participant to progress past the current stage. In step 440, tools for achieving the milestones can be provided and/or enabled in accordance with the detailed wellness plan.

For example, if the milestone to be achieved is primary a mental or psychological milestone, psychological tools can be provided. Tools can include classroom lessons, assignments that must be completed and designated scores achieved, automated counseling, group counseling, online counseling, psychologist assisted counseling sessions, and the like. In another example, if the milestone to be achieved is primarily a physical milestone, tools to achieve the milestone can be provided. Such tools can include classroom lessons, exercise programs, medical examinations, weight loss/gain goals, dietary restrictions, and the like.

In step 445, the performance of the participant can be evaluated. In step 450, a determination can be made as to whether a present stage of the participant's program has been successfully completed. If the stage has not been successfully completed, the participant may be advised to continue executing the current plan. Alternatively, a lack of results or stagnation within a single stage for a designated duration can trigger the method to loop back to step 425, where the system can re-evaluate the previously established milestone, adjusting them as appropriate. If in step 450, it is determined that the stage has been successfully completed, the method can proceed to step 455, where the participants metrics can be updated. The method can then loop to step 425, where details for the next stage can be determined along with stage specific milestones. Further, previously computed stages can be updated as necessary in light of changing participant metrics and the successful achievement of the previous stage.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for providing personalized wellness programs comprising the steps of:
receiving participant metrics, said metrics including data elements indicative of a plurality of mental and a plurality of physical attributes relating to wellness of an associated participant;
assigning numerical weights to selective ones of these metrics;
algorithmically determining a wellness program based at least in part upon the assigned weights, said wellness program including a plurality of stages that includes at least a first stage and at least a second stage;
presenting said first stage to said participant;
automatically evaluating participant performance of said first stage using a data-driven approach, said performance evaluation based at least in part upon said participant metrics; and
presenting said second stage when said evaluated performance indicates a successful completion of said first stage.

2. The method of claim 1, further comprising the steps of:
receiving participant metrics that are associated with a different participant; and
algorithmically determining a new wellness program for said different participant, said new wellness program including a plurality of stages based at least in part upon said received metrics associated with said different participant, said stages of said new wellness program being different from the stages determined for the previously established wellness program.

3. The method of claim 1, wherein said successful completion of said first stage requires said participant to overcome a mental milestone, said evaluating step further comprising the step of:
testing a mental state of said participant using a plurality of multiple choice questions;
scoring said test;
comparing said test score against a previously established threshold value, said comparing step determining said successful completion.

4. The method of claim 1, wherein said successful completion of said first stage requires said participant to overcome a physical milestone, said evaluating step further comprising the step of:
comparing a dietary metric against a previously established target value, said comparing step determining said successful completion.

5. The method of claim 1, wherein successful completion of said first stage requires said participant to overcome a mental milestone, and wherein successful completion of said second stage requires said participant to overcome a physical milestone.

6. The method of claim 1, said method further comprising the steps of:
during participant enrollment, presenting a plurality of questions to said participant, said receiving of participant metrics resulting from answers to said questions; and
determining a suitability of said participant based upon said participant metrics, wherein said participant is not permitted to enter said program is said suitability is below an established threshold.

7. The method of claim 1, said method further comprising the steps of:
selecting a digital coach from among a plurality of digital coaches, each digital coach having a simulated personality; and
interacting with said participant throughout said program via said selected digital coach.

8. The method of claim 1, said method further comprising the step of:
intermittingly determining a progression of said participant; and
suspending said participant from said program when said progression falls below an established minimum threshold.

9. A machine-readable storage having stored thereon, a computer program having a plurality of code sections, said code sections executable by a machine for causing the machine to perform the steps of:
receiving participant metrics, said metrics including data elements indicative of a plurality of mental and a plurality of physical attributes relating to wellness of an associated participant;
assigning numerical weights to selective ones of these metrics;
algorithmically determining a wellness program based at least in part upon the assigned weights, said wellness program including a plurality of stages that includes at least a first stage and at least a second stage;
presenting said first stage to said participant;
automatically evaluating participant performance of said first stage using a data-driven approach, said performance evaluation based at least in part upon said participant metrics; and
presenting said second stage when said evaluated performance indicates a successful completion of said first stage.

10. The machine-readable storage of claim 9, further comprising the steps of:
receiving participant metrics that are associated with a different participant; and
algorithmically determining a new wellness program for said different participant, said new wellness program including a plurality of stages based at least in part upon said received metrics associated with said different participant, said stages of said new wellness program being different from the stages determined for the previously established wellness program.

11. The machine-readable storage of claim 9, wherein said successful completion of said first stage requires said participant to overcome a mental milestone, said evaluating step further comprising the step of:
testing a mental state of said participant using a plurality of multiple choice questions;
scoring said test;
comparing said test score against a previously established threshold value, said comparing step determining said successful completion.

12. The machine-readable storage of claim 9, wherein said successful completion of said first stage requires said participant to overcome a physical milestone, said evaluating step further comprising the step of:
comparing a dietary metric against a previously established target value, said comparing step determining said successful completion.

13. The machine-readable storage of claim 9, wherein successful completion of said first stage requires said participant to overcome a mental milestone, and wherein successful completion of said second stage requires said participant to overcome a physical milestone.

14. The machine-readable storage of claim 9, further comprising the steps of:
during participant enrollment, presenting a plurality of questions to said participant, said receiving of participant metrics resulting from answers to said questions; and
determining a suitability of said participant based upon said participant metrics, wherein said participant is not permitted to enter said program is said suitability is below an established threshold.

15. The machine-readable storage of claim 9, further comprising the steps of:
selecting a digital coach from among a plurality of digital coaches, each digital coach having a simulated personality; and
interacting with said participant throughout said program via said selected digital coach.

16. The machine-readable storage of claim 9, further comprising the step of:
intermittingly determining a progression of said participant; and
suspending said participant from said program when said progression falls below an established minimum threshold.

17. A system for establishing personalized wellness programs comprising:
a participant data engine configured to security store participant metrics;
a program engine configured to establish and maintain personalized wellness programs for program participants, wherein each wellness program is customized for a participant based upon said participant metrics, said wellness programs including a plurality of progressive stages, at least a portion of said stages requiring a mental milestone to be achieved before successful stage completion and at least a portion of said stages requiring a physiological milestone to be achieved before successful stage completion; and
a coach engine including a plurality of digital coaches, each coach having an associated appearance, simulated personality, and coaching style, each participant accessing said system having a selected digital coach that guides the participant through a wellness program established for that participant.

18. The system of claim 17, further comprising:
a college tool configured to provide electronically administered lessons used to help program participants achieve designated milestones.

19. The system of claim 17, further comprising:
a nutritional laboratory tool configured to teach participants about scientific concepts concerning nutritional aspects relating to food.

20. The system of claim 17, further comprising:
a gym tool configured to provide personalized exercise programs.

21. The system of claim 17, further comprising:
a library tool configured to provide access to electronic books that have been specifically identified as beneficial for a participants wellness program.
